(19) United States
(12) Patent Application Publication
(10) Pub. No.: US 2024/0261896 A1
(43) Pub. Date: Aug. 8, 2024

(54) LASER PROCESSING APPARATUS

(71) Applicant: Panasonic Intellectual Property Management Co., Ltd., Osaka (JP)

(72) Inventors: NAOHIRO MURAYAMA, Osaka (JP); MASATOSHI NISHIO, Osaka (JP); JINGBO WANG, Hyogo (JP)

(21) Appl. No.: 18/641,270

(22) Filed: Apr. 19, 2024

Related U.S. Application Data
(63) Continuation of application No. PCT/JP2023/031169, filed on Aug. 29, 2023.

(30) Foreign Application Priority Data
Sep. 8, 2022 (JP) 2022-142791

(51) Int. Cl. B23K 26/08; B23K 26/064

(52) U.S. Cl. CPC B23K 26/08; B23K 26/064

(57) ABSTRACT

Robot arm (11) is provided with support member (30). Support member (30) includes first support (31), second support (32), and rotator (36). First support (31) supports linear member (4). Second support (32) supports transmission fiber (3) at a position farther from robot arm (11) than first support (31). Rotator (36) rotatably supports second support (32) about rotation axis (37) extending along a radial direction of transmission fiber (3).

### TECHNICAL FIELD

The present disclosure relates to a laser processing apparatus.

### BACKGROUND ART

PTL 1 discloses an optical fiber cable holding mechanism in which the middle of a transmission fiber (optical fiber cable) is suspended by a spring balancer, and the spring balancer is independently movable in a state of being capable of interlocking with movement of a laser beam torch.

### Citation List

### Patent Literature

PTL 1: Unexamined Japanese Patent Publication No. 2010-214437

### SUMMARY OF THE INVENTION

In the disclosure of PTL 1, it is necessary to increase the distance between the laser beam torch and the spring balancer, and when the laser beam torch is moved at a high speed, the transmission fiber is swung by its own inertia and bends like a whip.

Since the movement trajectory of the transmission fiber is greatly affected by the teaching operation of a robot arm like this, and the movement trajectory is also unpredictable, the transmission fiber may be broken due to bending or twisting of the transmission fiber.

The present disclosure has been made in view of such a point, and an object thereof is to suppress breakage of a transmission fiber associated with the movement of a robot arm.

A first disclosure is a laser processing apparatus that emits laser light transmitted to a laser processing head via a transmission fiber, the laser processing apparatus including a robot arm that moves the laser processing head and changes an emission position of the laser light, a linear member including at least one of a wire or a pipe connected to the laser processing head and extending along the transmission fiber, and a support member that is provided on the robot arm and supports the transmission fiber and the linear member, wherein the support member includes a first support that supports the linear member, a second support that supports the transmission fiber at a position farther from the robot arm than the first support, and a rotator that rotatably supports the second support about a rotation axis extending along a radial direction of the transmission fiber.

In the first disclosure, even when the transmission fiber is swung by its own inertia associated with the movement of the robot arm, the transmission fiber can be rotated independently of the rotation operation of the robot arm. This makes it possible to reduce the occurrence of bending, twisting, pulling, and the like in the transmission fiber and to suppress breakage of the transmission fiber.

A second disclosure is the laser processing apparatus according the first disclosure, the laser processing apparatus including a restriction member that links the transmission fiber and the linear member and restricts separation of the transmission fiber from the linear member by a predetermined distance or more.

In the second disclosure, it is possible to restrict the transmission fiber so that the transmission fiber and the linear member are not separated from each other by a certain distance or more when the transmission fiber is swung by its own inertia associated with the movement of the robot arm. This can prevent the transmission fiber from colliding with the robot arm.

A third disclosure is the laser processing apparatus according to the first or second disclosure, the laser processing apparatus including a protective tube extending along an axial direction of the transmission fiber and covering an outer peripheral portion of the transmission fiber, wherein the protective tube is supported by the second support, and the transmission fiber is allowed to rotate in a circumferential direction inside the protective tube.

In the third disclosure, the transmission fiber rotates in the circumferential direction inside the protective tube associated with the rotational operation of the robot arm, which makes it possible to reduce the occurrence of twisting in the transmission fiber.

According to the present disclosure, it is possible to suppress breakage of a transmission fiber associated with the movement of a robot arm.

### BRIEF DESCRIPTION OF THE DRAWINGS

FIG. 1 is an overall configuration diagram of a robot according to the present exemplary embodiment.

FIG. 2 is a perspective view illustrating a configuration of a support member.

FIG. 3 is a cross-sectional view illustrating a configuration of a transmission fiber and a protective tube.

### DESCRIPTION OF EMBODIMENT

Hereinafter, exemplary embodiments of the present disclosure will be described with reference to the drawings. Note that the following description of preferable exemplary embodiments is merely exemplary in nature, and is not intended to limit the present disclosure, its application, or its use.

### <Laser processing apparatus>

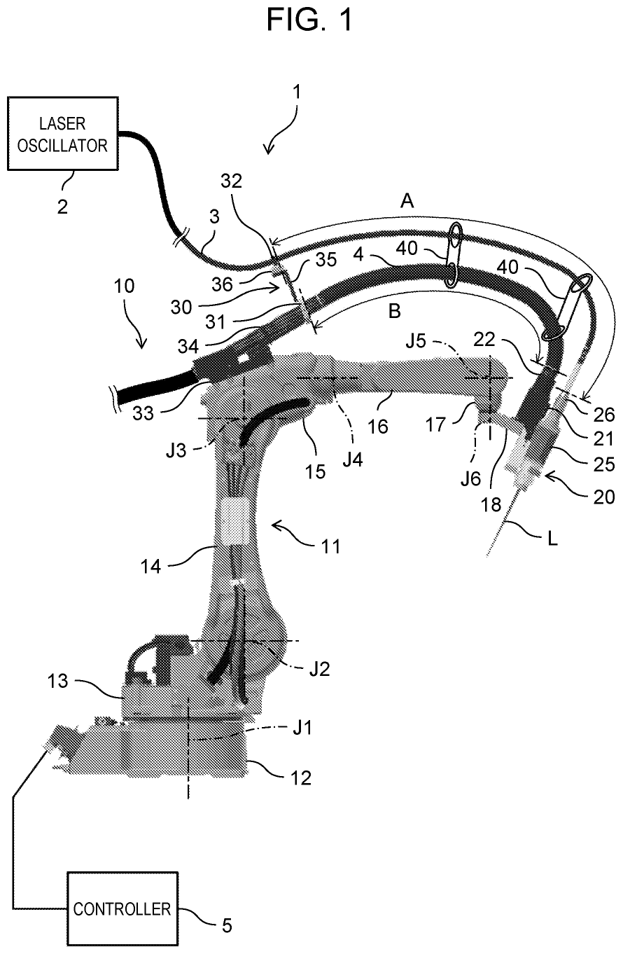

As illustrated in FIG. 1, laser processing apparatus 1 includes laser oscillator 2, transmission fiber 3, linear member 4, controller 5, robot 10, and laser processing head 20.

Laser oscillator 2 oscillates laser light L. As laser oscillator 2, for example, a solid-laser light source, a gas laser light source, or a fiber laser light source can be used. Laser oscillator 2 maybe a semiconductor laser light source that directly uses emitted light from a semiconductor laser, or a semiconductor laser array including a plurality of laser light emitters.

Laser oscillator 2 is connected to an inlet end of transmission fiber 3. Laser processing head 20 is connected to an emission end of transmission fiber 3. Laser light L emitted from laser oscillator 2 is transmitted to laser processing head 20 through transmission fiber 3.

Linear member 4 includes at least one of a wire or a pipe connected to laser processing head 20. The linear member 4 extends along transmission fiber 3. One end of linear member 4 is connected to adapter 21 of laser processing head 20.

When an electric wire is included as linear member 4, the other end of linear member 4 is connected to controller 5. In this case, for example, a signal from a sensor (not illustrated) provided on laser processing head 20 is sent to controller 5.

When an air pipe is included as linear member 4, the other end of linear member 4 is connected to an air supply unit (not illustrated). In this case, air is supplied from the air supply unit to laser processing head 20, and air is blown between laser processing head 20 and a workpiece.

When a water pipe is included as linear member 4, the other end of linear member 4 is connected to a water supply unit (not illustrated). In this case, water is supplied from the water supply unit to laser processing head 20, and laser processing head 20 is cooled by the water.

Laser processing head 20 emits laser light L to a workpiece (not illustrated). Laser processing head 20 includes adapter 21 and head body 25. Adapter 21 is provided with first connector 22. One end of linear member 4 is connected to first connector 22.

A collimator lens, a focus lens, a protective lens, and the like (not illustrated) are disposed inside head body 25. Head body 25 is provided with second connector 26. An emission end of transmission fiber 3 is connected to second connector 26.

Laser processing head 20 is attached to robot 10. Laser processing head 20 can change the emission position and the focal position of laser light L with respect to workpiece by operating robot 10.

Laser oscillator 2, robot 10, and laser processing head 20 are connected to controller 5. Controller 5 controls not only the moving speed of laser processing head 20 but also starting and stopping of output of laser light L, output intensity of laser light L, and the like.

### <Robot>

Robot 10 includes six-axis articulated robot arm 11. Controller 5 is connected to robot 10. Controller 5 controls the operation of robot arm 11.

Robot arm 11 includes base 12, shoulder 13, lower arm 14, first upper arm 15, second upper arm 16, wrist 17, and attachment 18.

Shoulder 13 is pivotably supported on base 12 in a horizontal direction about first joint J1. Lower arm 14 is pivotably supported on shoulder 13 in a vertical direction about second joint J2.

First upper arm 15 is pivotably supported on lower arm 14 in a vertical direction about third joint J3. Second upper arm 16 is supported on the distal end of first upper arm 15 in a torsionally rotatable manner about fourth joint J4.

Wrist 17 is pivotably supported on second upper arm 16 in a vertical direction around fifth joint J5. Attachment 18 is supported on wrist 17 in a torsionally rotatable manner about sixth joint J6. Laser processing head 20 is attached to attachment 18.

An actuator (not illustrated) is built in each of first joint J1 to sixth joint J6. Controller 5 controls driving of the actuators of first joint J1 to sixth joint J6 based on an operation program input in advance by teaching or the like so that first joint J1 to sixth joint J6 reach target positions (command angles), respectively.

### <Support member>

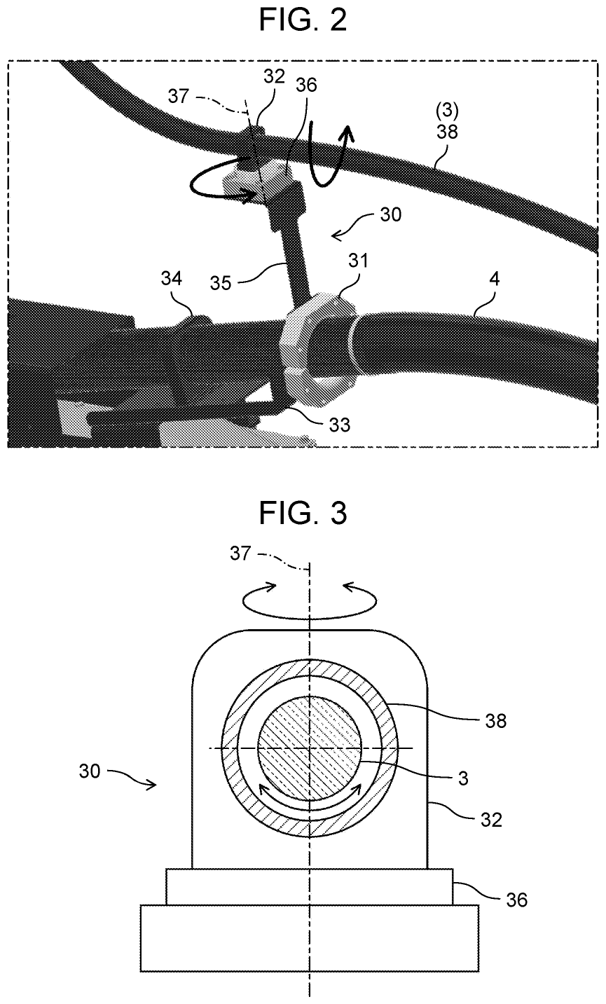

As also illustrated in FIG. 2, robot arm 11 is provided with support member 30. Support member 30 supports transmission fiber 3 and linear member 4. Support member 30 includes first support 31, second support 32, mount 33, fixture 34, erect part 35, and rotator 36.

Mount 33 is provided on an upper surface of first upper arm 15 of robot arm 11. A part of linear member 4 is placed on mount 33. Mount 33 is provided with first support 31 and fixture 34. Fixture 34 fixes linear member 4 to mount 33.

First support 31 is disposed closer to laser processing head 20 than fixture 34 is. First support 31 is formed in a ring shape through which linear member 4 is inserted. First support 31 supports linear member 4 in a state where slight movement of linear member 4 in a radial direction is allowed.

This makes it possible to reduce concentration of stress in the vicinity of fixture 34 of linear member 4 when linear member 4 is swung by its own inertia associated with the movement of robot arm 11 and to suppress breakage of linear member 4.

Erect part 35 is erected from mount 33 in a direction away from robot arm 11. Erect part 35 is erected in the vicinity of first support 31. Erect part 35 is formed of a plate-like member in which a tip is bent.

Rotator 36 is provided at the tip of erect part 35. Rotator 36 includes a bearing (not illustrated). Second support 32 is attached to rotator 36. Rotator 36 rotatably supports second support 32 about rotation axis 37 extending along the radial direction of transmission fiber 3 (an erecting direction of erect part 35 in FIG. 2).

Second support 32 supports transmission fiber 3 at a position farther from robot arm 11 than first support 31 via erect part 35 and rotator 36.

In the present exemplary embodiment, as illustrated in FIG. 1, distance A from second connector 26 to second support 32 in transmission fiber 3 is longer than distance B from first connector 22 to first support 31 in linear member 4.

With such a configuration, even when transmission fiber 3 is swung by its own inertia associated with the movement of robot arm 11, transmission fiber 3 can be rotated independently of the rotation operation of robot arm 11. This makes it possible to reduce the occurrence of bending, twisting, pulling, and the like in transmission fiber 3 and to suppress breakage of transmission fiber 3.

As illustrated in FIG. 3, transmission fiber 3 is protected by protective tube 38. Protective tube 38 extends along an axial direction of transmission fiber 3 and covers the outer peripheral portion of transmission fiber 3. Protective tube 38 is supported by second support 32. Transmission fiber 3 is rotatable in a circumferential direction inside protective tube 38.

This causes transmission fiber 3 to rotate in the circumferential direction inside protective tube 38 associated with the rotational operation of robot arm 11, which makes it possible to reduce the occurrence of twisting in transmission fiber 3.

As illustrated in FIG. 1, transmission fiber 3 and linear member 4 are linked by restriction member 40. Restriction member 40 is formed of, for example, a chain, a stainless wire, a spring, or the like. Restriction member 40 restricts separation of transmission fiber 3 from linear member 4 by a predetermined distance or more.

With such a configuration, it is possible to restrict transmission fiber 3 so that transmission fiber 3 and linear member 4 are not separated from each other by a certain distance or more when transmission fiber 3 is swung by its own inertia associated with the movement of robot arm 11. This can prevent transmission fiber 3 from colliding with robot arm 11.

In the example illustrated in FIG. 1, two restriction members 40 are provided between laser processing head 20 and support member 30. Of two restriction members 40, restriction member 40 closer to support member 30 links transmission fiber 3 at a position extending along the radial direction from the linking position in linear member 4.

On the other hand, of two restriction members 40, restriction member 40 closer to laser processing head 20 links transmission fiber 3 at a position further away in the axial direction from the position extending along the radial direction from the linking position of linear member 4.

Specifically, the distance from the linking position of transmission fiber 3 in restriction member 40 to second connector 26 of laser processing head 20 is longer than the distance from the linking position of linear member 4 in restriction member 40 to first connector 22 of adapter 21.

With this configuration, when the movement in the axial direction occurs between linear member 4 and transmission fiber 3 associated with the movement of robot arm 11, transmission fiber 3 can follow the movement.

### <<Other exemplary embodiments>>

The exemplary embodiment may have the following configuration.

In the present exemplary embodiment, a configuration in which linear member 4 is disposed along transmission fiber 3 has been described, but a wire, a pipe, and the like of another device may be disposed so as to extend along linear member 4. For example, a filler wire as a filler metal for arc welding may be disposed so as to extend along linear member 4.

In the present exemplary embodiment, the occurrence of twisting in transmission fiber 3 is reduced by covering transmission fiber 3 with protective tube 38 and making transmission fiber 3 rotatable in a circumferential direction inside protective tube 38, but the present invention is not limited to this form. For example, a rotation mechanism that rotatably supports second support 32 about a rotation axis (not illustrated) extending along the axial direction of transmission fiber 3 maybe provided.

In the present exemplary embodiment, transmission fiber 3 and linear member 4 are prevented from being swung around by their inertia between laser processing head 20 and support member 30. Portions of transmission fiber 3 and linear member 4 upstream of support member 30 maybe suspended and held by a balancer or fixed to a device other than robot arm 11 or a wall surface, for example.

### INDUSTRIAL APPLICABILITY

As described above, the present disclosure is extremely useful and has high industrial applicability since a highly practical effect that breakage of a transmission fiber associated with the movement of a robot arm can be suppressed is obtained.

### REFERENCE MARKS IN THE DRAWINGS

1: laser processing apparatus
3: transmission fiber
4: linear member
11: robot arm
20: laser processing head
30: support member
31: first support
32: second support
36: rotator
37: rotation axis
38: protective tube
40: restriction member
L: laser light

1. A laser processing apparatus that emits laser light transmitted to a laser processing head via a transmission fiber, the laser processing apparatus comprising:
a robot arm that moves the laser processing head and changes an emission position of the laser light;
a linear member including at least one of a wire or a pipe connected to the laser processing head and extending along the transmission fiber; and
a support member that is provided on the robot arm and supports the transmission fiber and the linear member,
wherein the support member includes:
a first support that supports the linear member;
a second support that supports the transmission fiber at a position farther from the robot arm than the first support; and
a rotator that rotatably supports the second support about a rotation axis extending along a radial direction of the transmission fiber.

2. The laser processing apparatus according to claim 1, the laser processing apparatus comprising a restriction member that links the transmission fiber and the linear member and restricts separation of the transmission fiber from the linear member by a predetermined distance or more.

3. The laser processing apparatus according to claim 1, the laser processing apparatus comprising a protective tube extending along an axial direction of the transmission fiber and covering an outer peripheral portion of the transmission fiber, wherein the protective tube is supported by the second support, and the transmission fiber is allowed to rotate in a circumferential direction inside the protective tube.
